(19) United States
(12) Patent Application Publication
(10) Pub. No.: US 2005/0114148 A1
(43) Pub. Date: May 26, 2005

(54) System, apparatus and method of automatically verifying conformance of documents to standardized specifications

(75) Inventor: Scott Robert Hinkelman, Austin, TX (US)

Correspondence Address: Mr. Volel Emile, P.O. Box 202170, Austin, TX, 78720-2170, US

(73) Assignee: International Business Machines Corporation, Armonk, NY (US)

(21) Appl. No.: 10/718,088

(22) Filed: Nov. 20, 2003

(51) Int. Cl. G06F 17/60

(52) U.S. Cl. 705/1

(57) ABSTRACT

A system, apparatus and method of automatically verifying that items required in a document conformant to a business-to-business standardized specification are in the document are provided. When the document is being received by a party, it is automatically checked to determine whether it contains at least one standardized specification conformance statement. If so, it is verified that information relating to the statement is conformant to the standardized specification as well as to policies adopted by the party.

### BACKGROUND OF THE INVENTION

1. Technical Field

The present invention is directed to standardized specifications. More specifically, the present invention is directed to a system, apparatus and method of automatically verifying conformance of documents to standardized specifications.

2. Description of Related Art

In recent years there has been a trend toward standardizing business-to-business (B2B) transfer of electronic data. For example, the United Nations Centre for Trade Facilitation and Electronic Business (UN/CEFACT) and the Organization for the Advancement of Structured Information Standards (OASIS) have recently joined forces to initiate a worldwide project to standardize B2B data transactions. Further, the Open Applications Group, Inc., which is a consortium of companies, has defined an Open Applications Group Integration Specification (OAGIS). OAGIS enables businesses within an industry or across industries to transact data effortlessly.

However, despite this standardization trend, there remain instances when business documents need to conform to policies set on a business to business basis. As an example, based on different needs exhibited by various industries and/or businesses, most items in a standardized business specification are listed as optional rather than as required. Any business document designed based on the B2B specification may be labeled as being conformant to the specification. This scheme works fine if a company does not require that any particular item be present in a business document. However, for any company that requires that certain items be present in a document, for example, this scheme may not be ideal. In such a case, the company may not rely on a claim that a business document is conformant to the business specification to infer that the document contains the required items.

Thus, a system, apparatus and method are needed to verify that items that are required to be in a business document claiming to be conformant to a standardized business specification are indeed in the document. The system, apparatus and method should preferably do such verification automatically.

### SUMMARY OF THE INVENTION

The present invention provides a system, apparatus and method of automatically verifying that items required in a document conformant to a business-to-business standardized specification are in the document. When the document is being received by a party, it is automatically checked to determine whether it contains at least one standardized specification conformance statement. If so, it is verified that information relating to the statement is conformant to the standardized specification as well as to policies adopted by the party.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 depicts an exemplary XML document.

FIG. 5 depicts an exemplary XML schema that may be used to interpret the XML document.

FIG. 6 depicts an exemplary XML schema conformance model that may be used by the present invention.

FIG. 7 depicts an exemplary schematron.

FIG. 8 is a flowchart of a process that may be used to implement the invention.

### DETAILED DESCRIPTION OF THE PREFERRED EMBODIMENT

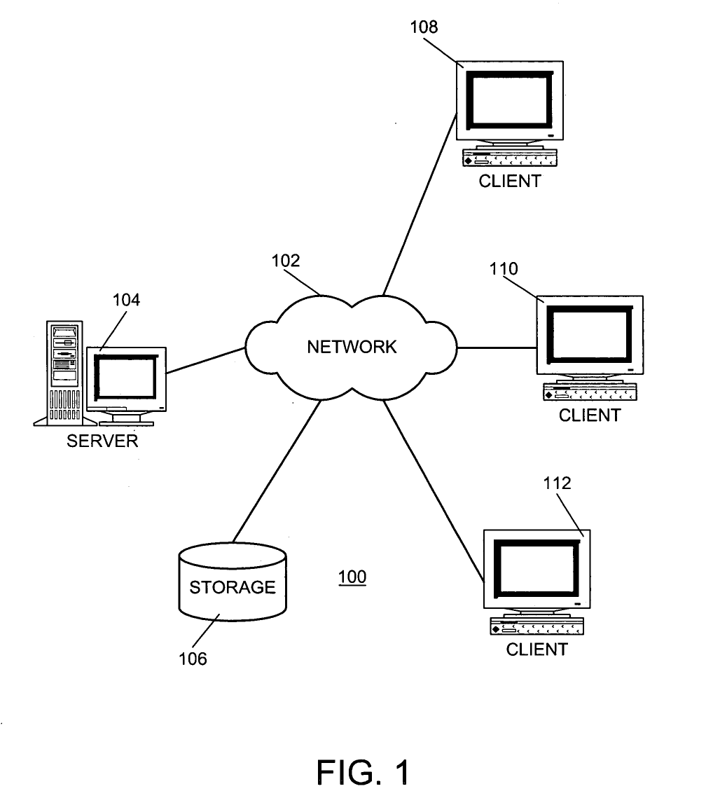

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

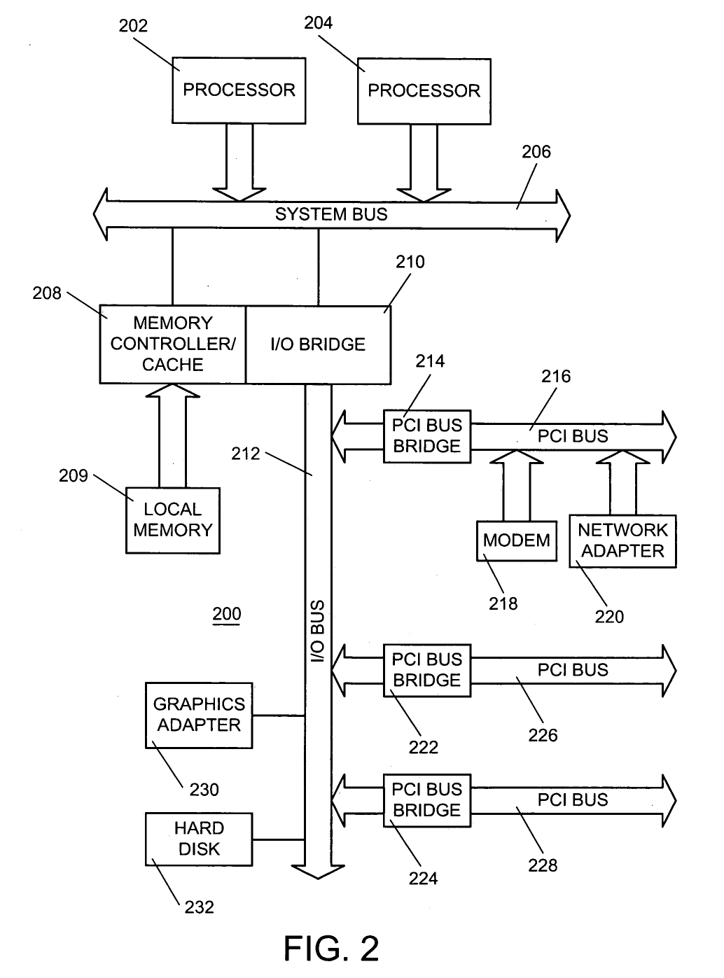

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

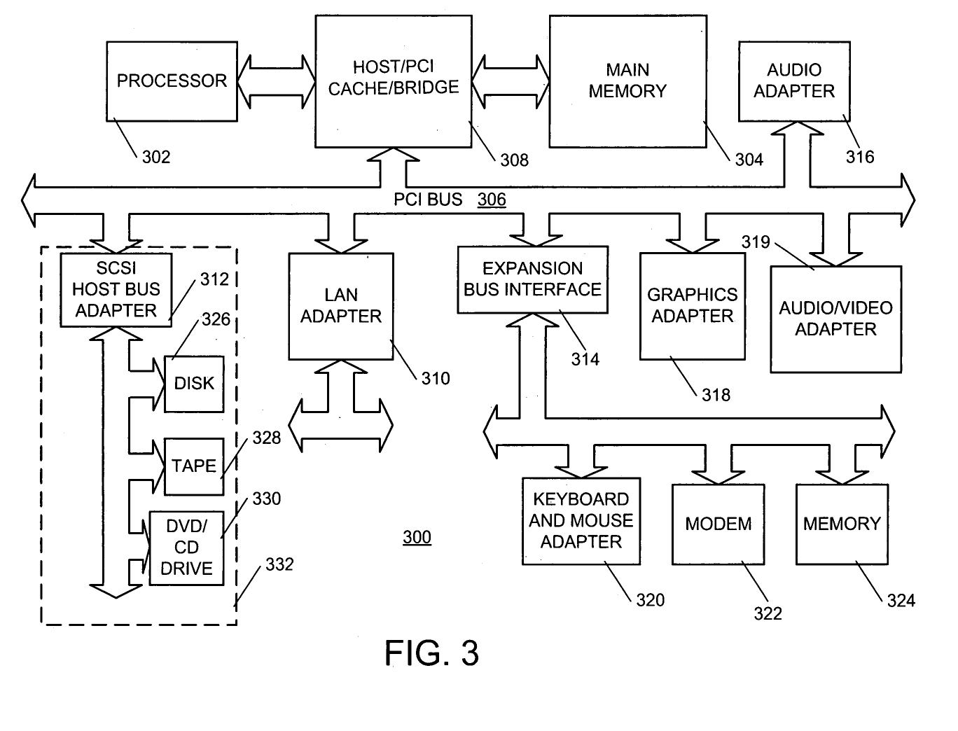

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM/DVD drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP™, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides a system, apparatus and method of verifying that required items are indeed included in a business document conformant to a standardized business specification. The invention may be local to client systems 108, 110 and 112 of FIG. 1 or to the server 104 or to both the server 104 and clients 108, 110 and 112. Further, the present invention may reside on any data storage medium (i.e., floppy disk, compact disk, hard disk, ROM, RAM, etc.) used by a computer system.

The eXtensible Markup Language (XML) has been approved as a standard for Web document formatting by the World Wide Web Consortium. As such, the present invention will be described using XML. However, it should be understood that the invention is not thus restricted. Any other formatting language or data type may be used and is within the scope and spirit of the invention. For example, MIME (Multipurpose Internet Mail Extensions) data types may be used as well. Consequently, XML and XML data types are only used for illustration purposes only.

XML is a markup language that has evolved from SGML (Standard Generalized Markup Language) and is a compromise between SGML, which is a rather complex and extensible language, and HTML (HyperText Markup Language), which is a simple but non-extensible language. A markup language is a language that uses tags to mark-up documents. The tags are used to give structure to documents which are in turn used as a means of communication. An extensible language enables users to create their own collection of tags.

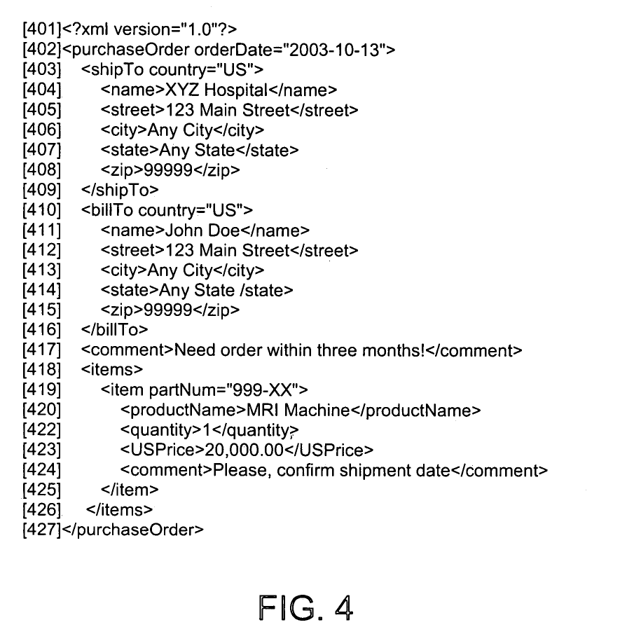

FIG. 4 depicts an exemplary XML document. The document is a purchase order for an MRI machine. The header of the purchase order (see line 402) indicates that it is an XML document that has been written using version 1.0 of the XML specification. The greater than (“>”) and the less than (“<”) signs are tags. They indicate the opening and closing of elements. Elements are the basic building blocks of an XML document. They may contain text, comments, or other elements. Every opening element (e.g., <items>) must also contain a closing element (e.g., </items>). The closing element consists of the name of the opening element, prefixed with a slash (“/”).

XML is case-sensitive. While “<items ></items>” is well-formed, “<ITEMS></items >” and “<Items></iTEMS>” are not. Also, if the element does not contain text or other elements, the closing tag may be abbreviated by simply adding a slash (“/”) before the closing bracket in the opening element (e.g., “<items></items>” can be abbreviated as “<items />”). In addition to the rules defining opening and closing tags, it is important to note that in order to create a well-formed XML document, the elements must be properly nested. All attribute values must be contained within quotation marks. For example, version=“1.0” is correct, while version=1.0 is not acceptable. Where elements represent the nouns contained in an XML document, attributes represent the adjectives that describe the elements.

Returning to FIG. 4, “purchaseOrder” (lines 402-427) is the main element and includes sub-elements “shipTo” (lines 403-409), “billTo” (lines 410-416), “comment” (line 417) and “items” (lines 418-426). Sub-element “items” itself includes sub-elements “item” (lines 419-425) and “comment” (line 424).

The “shipTo” sub-element includes the name of a person or entity to which the order is to be shipped as well as the address of the person or entity. In this case, the order is to be shipped to XYZ Hospital. Likewise, the “billTo” sub-element contains the name and address of the person or entity to be billed. Sub-element “item” (lines 419-425) described the product being purchased (i.e., and MRI machine), the number of MRI machines being purchased (i.e., one) and the price of the MRI machine (20,000.00 US dollars). The purchase order is dated Oct. 13, 2003 as shown on line 402.

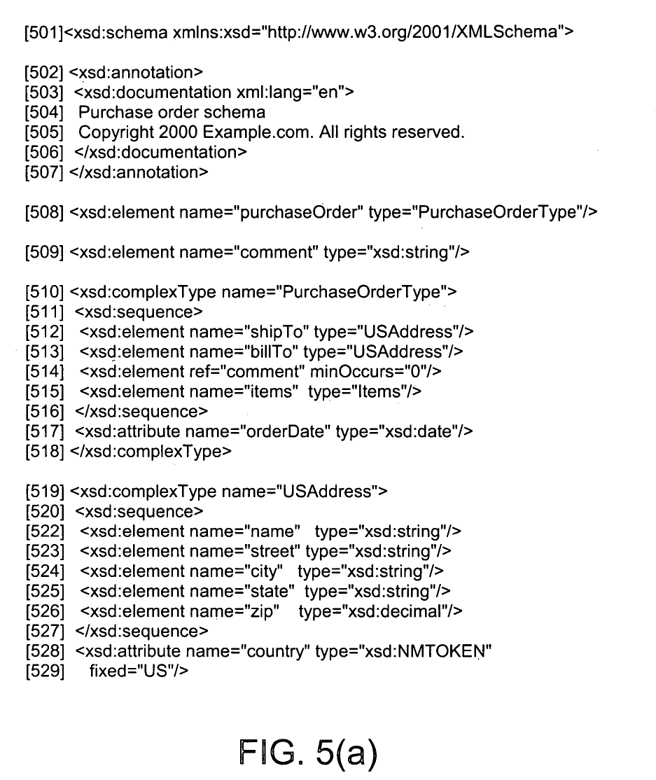

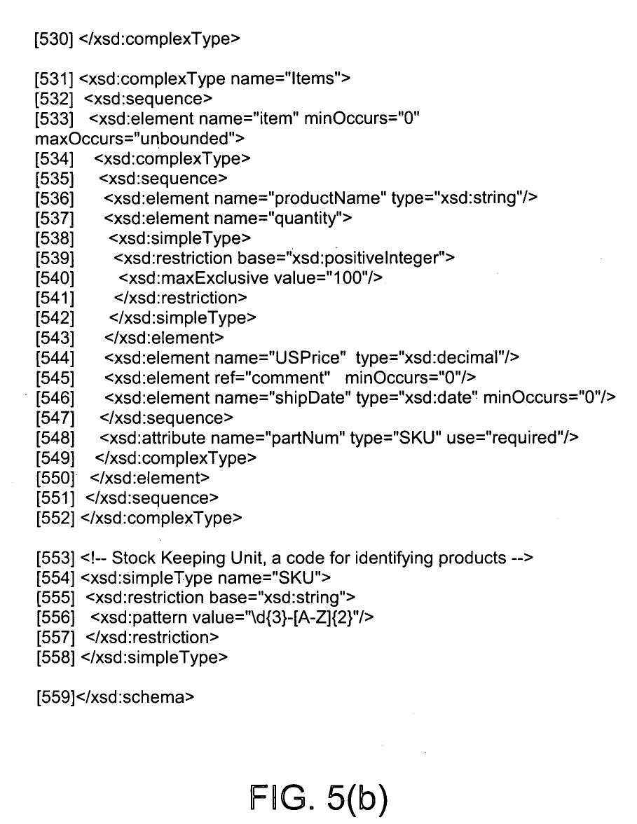

Since the element tags (including sub-elements) are user-defined, a Document Type Definition (DTD) or XML schema, or some other type of reference is needed to interpret the user-defined tags. In this example, an XML schema is used. An exemplary XML schema is depicted in FIG. 5. As stated in the current XML schema recommended by the W3C XML Schema Working Group which is provided in an Information Disclosure to be filed concurrently with the present patent application and which is incorporated herein by reference, each one of the elements in the schema has a prefix “xsd:”. The prefix “xsd:” is associated with the XML Schema namespace through declaration, xmlns:xsd=“http://www.w3.org/2001/XMLSchema”, that appears in the schema element. It is used by convention to denote the XML Schema namespace, although any prefix can be used. The purpose of the association is to identify the elements and types as belonging to the vocabulary of the XML Schema language rather than the vocabulary of the schema author.

In any case, on line 501 the document is identified as a schema and the Web location where it is stored is indicated. “Annotation” (lines 502-507), which contains a statement indicating that the document is written in English (see line 503), identifies the document as a purchase order schema (line 504). On line 508, “purchaseOrder” is defined as a purchaseOrderType. On line 509, “comment” is defined as a string type. PurchaseOrderType (lines 510-518), USAddress (lines 519-530) and “Items” (lines 531-549) are all defined as complex type. Other elements are defined as simple type (see lines 554-558). Complex types allow. elements in their content and may carry attributes while simple types cannot contain elements nor carry attributes. For a thorough explanation of XML schemas, the reference provided in the Information Disclosure statement may be consulted.

Suppose there is a Medical Consortium to which XYZ Hospital belongs and which has a standardized specification requiring all purchases of high-technological machines be preceded by a demonstration. Suppose further that the Hospital and the company to which the purchase order was sent have agreed that replies to offers to buy high-technological machines be conformant to the Medical Consortium standardized specification. Then, to be conformant to the standardized specification, the company's reply may have to include a demonstration date therein.

Suppose further that the Hospital has a policy requiring that equipment demonstrations be given by personnel having a certain amount of experience with the equipment. In order for the reply to be conformant to the Hospital's policy, the company may have to identify the person that will give the demonstration as well as indicating the person's amount of experience with the machine.

When the Hospital receives the reply from the company, the Hospital may want to ensure that the reply is indeed conformant to the Medical Consortium's specification as well as to its own policy before proceeding with the purchase. Thus, if the reply is an XML document, the Hospital may use an end-user application to convert the XML document (i.e., reply) to a human-friendly format (i.e., with all tags removed). The human-friendly format may then be rendered on a computer screen or printed in order to be easily inspected. But, since if the reply does not conform to the Hospital's policy or the standardized specification, it may be rejected for non-conformance, converting the document into a human-friendly format before its conformance is ascertained may be unnecessary. For efficiency reason, therefore, the document may be automatically checked for conformance before it is converted. A middleware package may preferably be used to ensure conformance of the reply to the Medical Consortium's specification as well to the Hospital's own policy.

Middleware is a general term used for any programming that serves to “glue together” or mediate between two separate and usually already existing programs. Thus, middleware is commonly known as the “plumbing” of an information system as it routes data and information transparently between different back-end data sources and end-user applications.

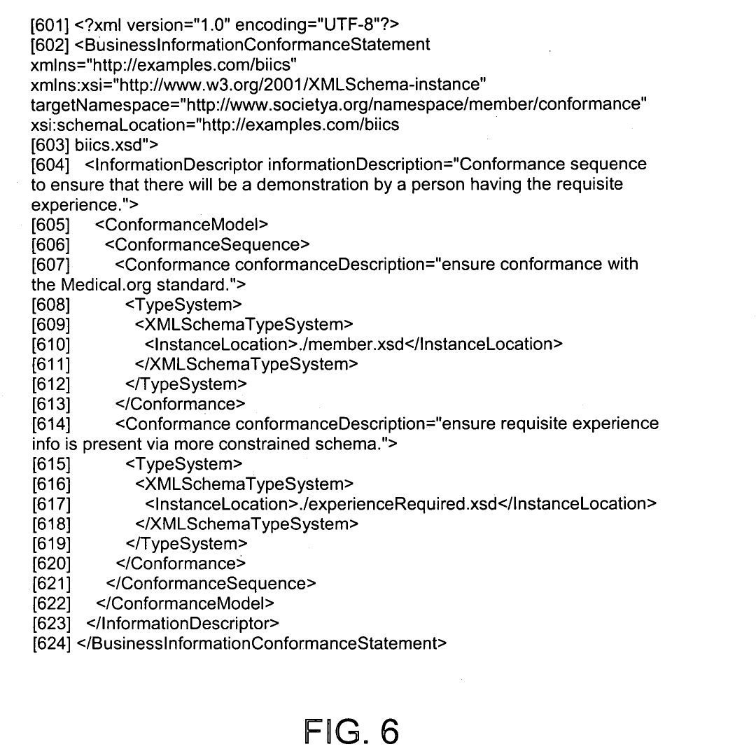

The middleware may check the reply for conformance using a procedure as outlined in FIG. 6. FIG. 6 depicts an exemplary XML schema conformance model that may be used by the present invention. Note that the schema in FIG. 6 is specifically designed to be used in conjunction with the example above. On lines 601 to 603, top-level elements such as XML version, storage locations of specifications, schemas etc., are defined. On lines 604 to 623, a business information within an information descriptor element, which declares the information as conformant to a sequential model (see lines 606 to 622) is described. The attribute on line 604 indicates that the conformance statement is for ensuring that a demonstration will ensue before the purchase.

On lines 607 to 613 the first conformance within the sequence is described by the conformanceDescription attribute on line 607. This conformance is a type system as indicated on lines 608 to 612. The type system is a W3C XML schema (see lines 609 to 611) and the XML schema instance is located as indicated on line 610. In this example, this would be the schema that has been defined my Medical.org (the Medical Consortium) requiring that a demonstration be given before purchase.

On lines 614 to 620 the second conformance within the sequence is described by the conformanceDescription attribute on line 614. This conformance is also a type system as indicated on lines 615 to 619. The type system is also a W3C XML schema per lines 616 to 618 and the XML schema instance is located as indicated on line 617. In this example, this would be the Hospital's policy (i.e., the requirement that a demonstration be given by a person with a certain amount of experience with the equipment).

In some instances, the conformance model may have requirements that other data types or languages be used at particular locations in a document. For example, if one of the policies of the Hospital is to have an image of the MRI machine being purchased in the reply, the conformance model may designate that the image be a JPEG (Joint Photographic Experts Group) image. By having such a requirement in the conformance model, the middleware may not only ensure that there is an image present in the document but that the image is of the proper type.

As alluded to above, a schema is used to define elements and their attributes. Using a schema, additional constraints may be added to certain information in the document. In XML, these additional constraints may be used to enable graph structures to be represented, rather than to describe semantics or types of information. But, an XML schema cannot check expressions of interlocking constraints in an XML document; nor can it check pre/post conditions of XML documents used as arguments or returned by functions in programming languages. To do so, a different language (e.g., schematron) may be used.

Schematron is a simple XML-based assertion language using patterns in trees. Its uses include validation and automated link generation. An assertion language is a high-level language that provides a formal grammar for expressing programmatic assertions. It can be used to automatically generate tests based on API specifications and to produce natural language representations of these assertions for documentation.

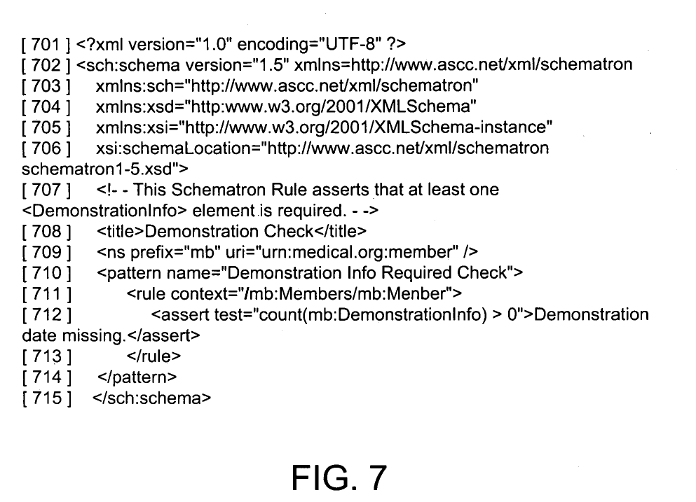

FIG. 7 depicts an exemplary schematron. The schematron may be used to determine whether the XML document contains the requisite demonstration date set. Specifically, the information on lines 701 to 706 defines top-level elements such as XML version, storage locations of specifications, schemas etc. On line 707 is a comment explaining the purpose of the schematron. The title of the schematron is on line 708 (i.e., Demonstration Check). On line 709, it is identified that the. Hospital is a member of the Medical Consortium (i.e., medical.org). The name of the check being made is called “Pattern Name” (see line 710). According to the schematron, any member of the Medical Consortium (line 711) and the rule is to check that (712). On lines 713-715 elements that were previously opened are closed.

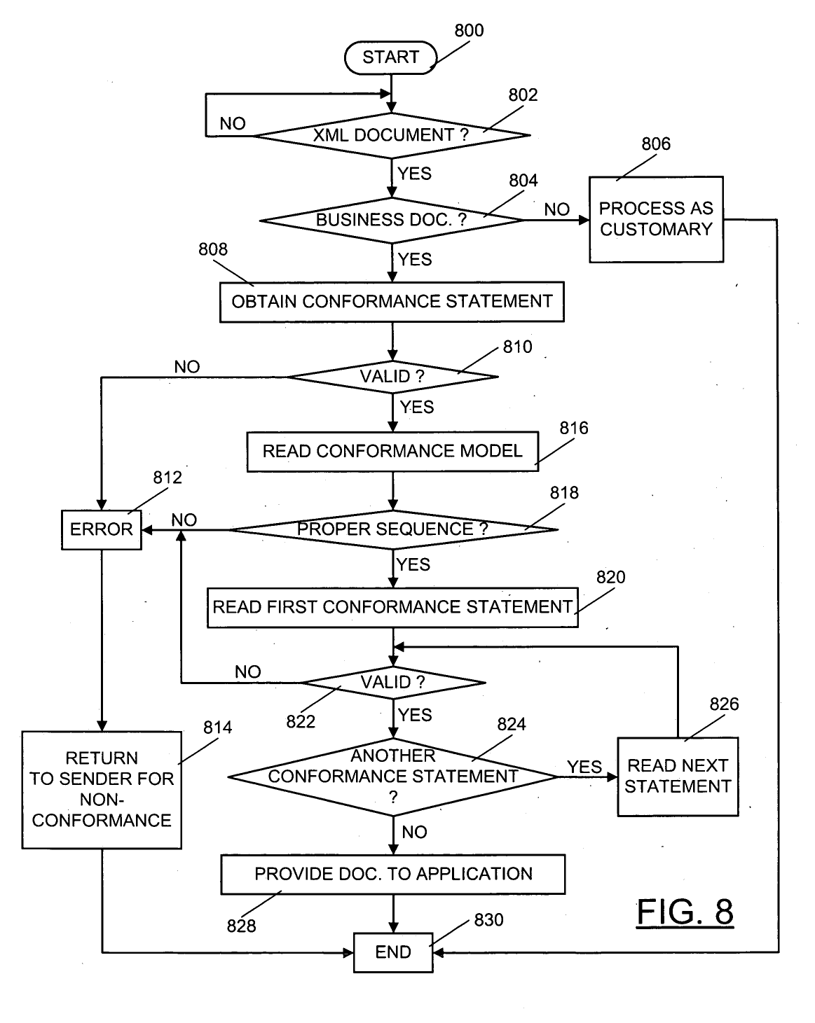

FIG. 8 is a flowchart of a process that may be used to implement the invention. The process starts when an XML document is received (steps 800 and 802), at which time a check is made to determine whether the document is a business document. To differentiate between a business document and a non-business document, a conformance statement may be used. If the document is not a business document, the process may continue as customary before it ends (steps 804, 806 and 830). If the document is a business document, the conformance statement may be scrutinized for validity. If the conformance statement is valid, the conformance model (e.g., FIG. 6) may be read in memory (steps 808, 810, 816).

Depending on the conformance model, there may be a specific sequence in which the conformance statements have to be listed in the business document. For example, some conformance models may require that the conformance statements in the business document follow a strict sequence and some others may not require a strict adherence to the sequence so long as they are present. The conformance model in FIG. 6 delineates a strict conformance statement sequence. Specifically, the first conformance statement in the business document needs to be in relation to the Medical Consortium standardized specification and the second needs to be in relation to the Hospital's policy.

If the statements are in proper sequence, they each will be checked for validity. To do so, the XML schema that indicates the information that needs to be present in the document in order for a conformance statement to be correct will be consulted. Specifically, the file represented by “member.xsd” (see line 610 of FIG. 6) will be accessed to determine whether the document is indeed conformant to the Medical Consortium standardized specification. Likewise, the file represented by “experienceRequired.xsd” will be accessed to determine whether the document is conformant to the Hospital's policy. Note that if “member.xsd” and “experienceRequired.xsd” are stored at a Web location, their Wed address will be used instead of their names.

In any case, to support the first conformance statement, a time and date for the demonstration of the equipment must be set in the document. Likewise, to support the second conformance statement, the name of the person demonstrating the equipment as well as the person's years of experience with the equipment must be stated. If so, the document may be sent to the application that will convert the document into a user-friendly format to be rendered on a computer screen, for example. The process may then end (steps 818, 820, 822, 824, 826, 828 and 830).

If the conformance statement is not valid (step 810) or the statements are not in the proper sequence (step 818) or any one of the conformance statements is not properly stated (step 822), an error statement may be generated and the document may be returned to the sender before the process ends (steps 812, 814 and 830).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of receiving a document by a party, the party having a set of policies, the method comprising the steps of:
receiving the document;
automatically determining whether the document contains at least one standardized specification conformance statement; and
automatically verifying, if the document contains the at least one standardized specification conformance statement, that information relating to the statement is conformant to the standardized specification as well as to the set of policies of the party.

2. The method of claim 1 wherein the verifying step includes the step of accessing the standardized specification and the policies for verification.

3. The method of claim 1 wherein the verifying step includes the step of accessing a conformance model for verification.

4. The method of claim 3 wherein the conformance model includes at least one conformance statement required in the document.

5. The method of claim 3 wherein the conformance model includes a plurality of conformance statements in a sequence that is required to be in the document in the same sequence.

6. A computer program product on a computer readable medium for facilitating a party to receive a document, the party having a set of policies, the computer program product comprising:
code means for receiving the document;
code means for automatically determining whether the document contains at least one standardized specification conformance statement; and
code means for automatically verifying, if the document contains the at least one standardized specification conformance statement, that information relating to the statement is conformant to the standardized specification as well as to the set of policies of the party.

7. The computer program product of claim 6 wherein the verifying code means includes code means for accessing the standardized specification and the policies for verification.

8. The computer program product of claim 6 wherein the verifying code means includes code means for accessing a conformance model for verification.

9. The computer program product of claim 8 wherein the conformance model includes at least one conformance statement required in the document.

10. The computer program product of claim 8 wherein the conformance model includes a plurality of conformance statements in a sequence that is required to be in the document in the same sequence.

11. An apparatus for receiving a document by a party, the party having a set of policies, the apparatus comprising:
means for receiving the document;
means for automatically determining whether the document contains at least one standardized specification conformance statement; and
means for automatically verifying, if the document contains the at least one standardized specification conformance statement, that information relating to the statement is conformant to the standardized specification as well as to the set of policies of the party.

12. The apparatus of claim 11 wherein the verifying means includes means for accessing the standardized specification and the policies for verification.

13. The apparatus of claim 11 wherein the verifying means includes means for accessing a conformance model for verification.

14. The apparatus of claim 13 wherein the conformance model includes at least one conformance statement required in the document.

15. The apparatus of claim 13 wherein the conformance model includes a plurality of conformance statements in a sequence that is required to be in the document in the same sequence.

16. A system for receiving a document by a party, the party having a set of policies, the system comprising:
at least one storage device for storing code data; and
at least one processor for processing the code data to receive the document, to automatically determine whether the document contains at least one standardized specification conformance statement, and to automatically verify, if the document contains the at least one standardized specification conformance statement, that information relating to the statement is conformant to the standardized specification as well as to the set of policies of the party.

17. The system of claim 16 wherein the code is further processed to access the standardized specification and the policies for verification.

18. The system of claim 16 wherein the code is further processed to access a conformance model for verification.

19. The system of claim 18 wherein the conformance model includes at least one conformance statement required in the document.

20. The system of claim 18 wherein the conformance model includes a plurality of conformance statements in a sequence that is required to be in the document in the same sequence.
